(19) United States
(12) Patent Application Publication
(10) Pub. No.: US 2003/0142238 A1
(43) Pub. Date: Jul. 31, 2003

(54) Automated presentation of a live event

(76) Inventors: Jay Wasack, Middletown, NJ (US); Christopher Greene, Toms River, NJ (US)

Correspondence Address: SCHNECK & SCHNECK, P.O. BOX 2-E, SAN JOSE, CA, 95109-0005, US

(21) Appl. No.: 10/167,174

(22) Filed: Jun. 10, 2002

Related U.S. Application Data
(60) Provisional application No. 60/296,802, filed on Jun. 8, 2001.

(51) Int. Cl. H04N 5/14

(52) U.S. Cl. 348/571; 348/590

(57) ABSTRACT

A method and system for triggering, composing, and displaying presentations of a live event, such as a sporting event. Prior to the event, data characterizing a set of triggering events and data characterizing a set of layout rotations is stored. Each layout rotation includes one or more layouts, and each of the layout rotations is associated with one of the triggering events. During the live event, instances of the triggering events are detected, at which time the associated layout rotation is automatically initiated.

### CROSS-REFERENCE TO RELATED APPLICATIONS

This application claims the benefit of U.S. Provisional Application No. 60/296,802 filed Jun. 8, 2001, which is incorporated herein by reference.

### BACKGROUND ART

This invention relates to automated presentation of video and multimedia of a live event.

Live events, such as sporting events, are often presented on video displays in real-time to one or more audiences. For example, at a sporting event, an audience in the stands viewing the event directly may also view video or still images on a number of scoreboard displays at the event. Another audience may have a closed-circuit television broadcast of the event, for example, in luxury suites overlooking the event and concourses. The scoreboards often show various content such as slow motion replays, game statistics for the event or for concurrent events at other venues, and advertising in a number of different layouts. The event may also be presented on broadcast or cable television stations.

At a typical live event, the presentations for the different displays and the different audiences are composed in real time by a number of people using computer-based composition tools. For example, the score or other statistics related to a game are manually composed into a display during the event as those statistics change. A number of commercially available hardware and software-based products, for example, designed for use in the television industry, are available to perform such composition.

Some products for composing television programming provide a capability to sequence different layouts based on predefined timing or schedule, and provide a capability to incorporate live text data. Examples of incorporation of live data include display of stock tickers or weather reports in conjunction with motion video programming. Sequencing of layouts can be controlled according to a time code or based on manual control by an operator.

### SUMMARY OF THE INVENTION

In one aspect, in general, the invention is a method for triggering, composing and displaying presentations of a live event. Prior to the live event, data characterizing a set of triggering events and data characterizing a set of layout rotations are stored. Each layout rotation including one or more layouts, and each of the layout rotations is associated with one of the triggering events. During the live event, instances of the triggering events are detected, and for each of said detected instances, a layout rotation associated with the triggering event is automatically initiated.

The invention can include one or more of the following features:

During the live event, the layouts of the triggered layout rotations are automatically displayed according to the stored data characterizing those layout rotations.

Automatically displaying the layouts includes displaying live, replay, slow-motion, or prerecorded video of the live event, or displaying animations and graphics.

Automatically displaying at least some of the layouts further includes displaying static or dynamic text and static or dynamic graphics based on real-time data feeds.

Automatically displaying at least some of the layouts further includes displaying one of a number of advertisements.

Different advertisements are displayed during display of layout rotations that are triggered by different triggering events.

During the live event, data related to the live event is received and the triggering events include events that are characterized in terms of that data.

The data related to the live event includes data characterizing discrete events during a sporting event. For example, the discrete events may include a scoring event, and the data characterizing the scoring event includes data identifying players who participated in the event.

The method further includes forming multiple separate presentations, each for display on a different one of a number of display systems. Automatically triggering layout rotations during the event then includes triggering different layout rotations for different of the separate presentations.

The display systems can include a scoreboard display visible to an audience attending the live event.

The display systems can include television monitors at the venue of the live event.

The display systems can include a television distribution system for displaying the event at locations other than at the venue of the live event.

In another aspect, in general, the invention is a presentation system that embodies the method for triggering, composing and displaying presentations of a live event. The system includes a programmable computer with a storage medium holding computer instructions for causing a computer to perform one or more steps of the method. The system can also include hardware dedicated to video processing.

The invention includes one or more of the following advantages.

The invention provides a mechanism for composing one or more presentations without requiring substantial human intervention during a live event. This has an advantage of reducing the resources required to produce multiple presentations, to produce presentations with complex and “interesting” graphics, or including dynamically updated text fields. Providing more complex and interesting graphics can provide a more appealing viewer experience, thereby increasing the number of viewers and in turn potentially increasing the amount of advertising revenue that can be generated using the display.

The presentation system is divided into a data entry or data capture component and a display composition component. The data entry can be performed without regard to how it will be specifically used to generate the displays. For example, a game statistician can enter the game statistics using a standard text syntax. Also, other data sources, such as sports, weather, or financial “tickers” can be used. The association of events that may be encoded in the data with particular displays or layouts is performed before the live event, thereby avoiding the time pressures that would be introduced by trying to compose the displays in real time.

Additional displays can be added without increasing the production costs substantially. For example, different closed circuit television channels can be produced sharing many rotations and layouts in common, but with the rotations potentially being triggered at different occasions.

The approach is suited to targeted advertising in which sponsors select particular times at which they want their advertising to be displayed. In addition to specifying absolute times, the invention allows sponsors to purchase advertising rights associated with particular triggering events. Furthermore, since layouts are designed prior to a game, the layouts can integrate the sponsors advertising into the overall display with other dynamic elements such as live video and game scores in a way that might be difficult to do in real time during the live event. Therefore, the value of advertising to sponsors may be increased by providing a better overall layout and presenting the advertising during occasions specifically selected by the sponsor.

Other features and advantages of the invention are apparent from the following description, and from the claims.

### BRIEF DESCRIPTION OF THE DRAWINGS

FIG. 1 is a diagram illustrating composition and display of multiple presentations of a live sporting event according to the invention.

FIG. 2 is a block diagram of a presentation processor, which is used to compose multiple presentations from a number of video and data sources.

FIG. 3 is a diagram illustrating configuration data that is used to compose the presentations of the live event.

FIG. 4 is a diagram that illustrates a representative layout that is stored in the configuration data.

### BEST MODE FOR CARRYING OUT THE INVENTION

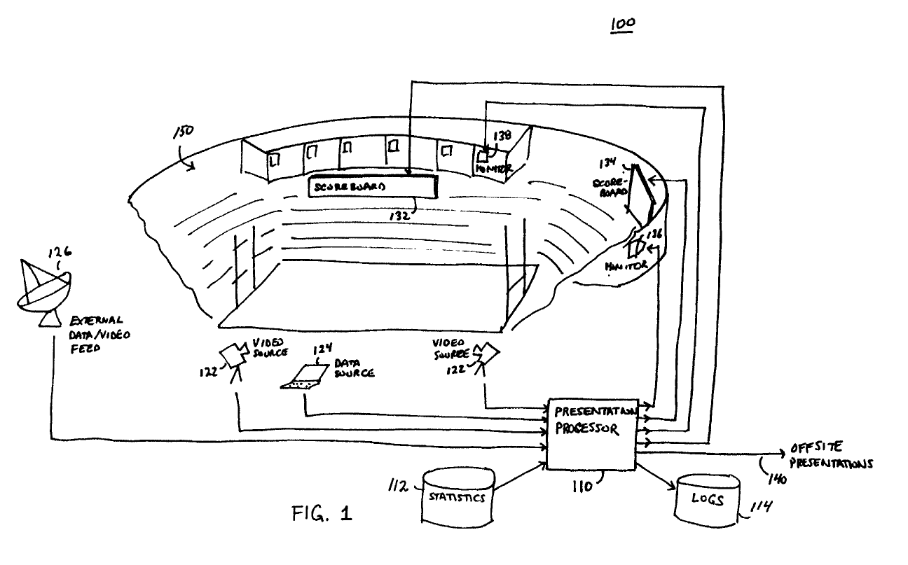

Referring to FIG. 1, according to the invention, a presentation system 100 composes a number of presentations of a live event for display to audiences at the event, or at offsite locations other than the venue of the live event. As illustrated in FIG. 1, the invention is applied to a sporting event, and the venue of the sports event is a sports stadium, including the stands, luxury boxes overlooking the event, and locations at the venue that are not in view of the live event, such as mezzanines, restaurants, or bars. It should be understood, however, that the invention is not limited to application to sporting events and is applicable to a wide variety of live events.

As illustrated in FIG. 1, the event is presented on a number of display systems. These display systems include scoreboards 132 and 134, television monitors 136 and 138, offsite presentation system 140. Scoreboards 132 and 134 provide capabilities that allow video to be displayed. Note that scoreboard 132 and scoreboard 134 may have different aspect ratios. As illustrated in FIG. 1, scoreboard 132 is much wider that a television screen while scoreboard 134 is taller than a television screen. Television monitors 136 are in locations from which the event cannot be directly viewed, such as from a concourse, or in lounges and restaurants at the venue. Television monitors 138 are in luxury suites at the event from which audiences can both view the live event directly. Offsite presentation system 140 can include a limited distribution television signal, for example, distributed to offsite “sports bars” or over subscription cable systems.

Different presentations are displayed on each of the display systems, such as on each scoreboard. Furthermore, even if the various scoreboards at the event have the same aspect ratio, different of these scoreboards may be used to display different presentations. For example, end-zone scoreboards may display different information than a sidelines display, and each end-zone scoreboard may display different images depending on which end of the field the sport play is taking place. Similarly, television monitors 136 and 138 may have different presentations, for example, taking into account that the audience in the luxury suites can view the event directs as well as on the television monitors, while audiences in a concourse or in a lounge or restaurant do not have a direct view of the event.

Generation of different presentations for different display systems may also be related to display of different advertising on the different systems. For example, different sponsors may purchase advertising rights for different display systems and the different presentations reflect these advertising differences. For example, one sponsor may purchase the right to display a “frame” around live video on the scoreboard, while another sponsor may purchase a right to a full-screen advertisement for display on video monitors in bars and restaurants at the venue.

The various presentations for display on the display systems are generated using a presentation processor 110. Presentation processor 110 is configured prior to the live event and then during the event generates the different presentations largely or entirely without operator intervention. The configuration prior to the event takes into account the characteristics of the display systems, such as their aspect ratios, as well as the audiences for each of the display systems, as well as the advertising rights of sponsors on the different display systems.

Presentation processor 110 receives video of the live event from one or more cameras 122 or a production control room 123, which processes video from cameras 122. The production control room selects the video source sent to presentation processor 110. The video sources sent to presentation processor 110 may be live, instant-replay, slow-motion or prerecorded video. In addition to these video sources, presentation processor 110 also receives a data signal from a data source 124. In this embodiment, data source 124 is a console at which an operator uses a keyboard to annotate discrete events during the live event as they occur. For example, the data source is a computer executing the @Game® software application, which is available from XstreamSports Inc. The discrete events are encoded using a standard syntax that allows detection of events in the data stream that is passed from data source 124 to presentation processor 110. For example, for a sporting event, the operator at data source 124 enters events such as scores, beginning and ends of plays in sports with discrete plays such as football, and changes of possession for sports with continuous play such as basketball. For each of these events, the operator may also include information characterizing the event, such as an identification of players involved in the event, the type of play, or the position on the field of the play. Presentation processor 110 also receives video and data from an external data/video feed 126. For example, video signals from concurrent sporting events at other venues, and annotations, such as those obtained from data source 124 but for those concurrent sporting events, or in standard data formats such as Stats Inc.® or SportsTicker Sportswire®, are passed to presentation processor.

Presentation processor 110 also has available statistics 112, which includes a database of team and player statistics that it uses to add dynamically updated information to the presentations. These statistics may be updated during the live event so that they remain up-do-date.

Presentation processor 110 also creates logs 114 which identify what was displayed on the various display systems. One use of such logs is to determine which advertising was displayed, for example, to determine the payments for that advertising or to verify that particular advertising requirements were satisfied.

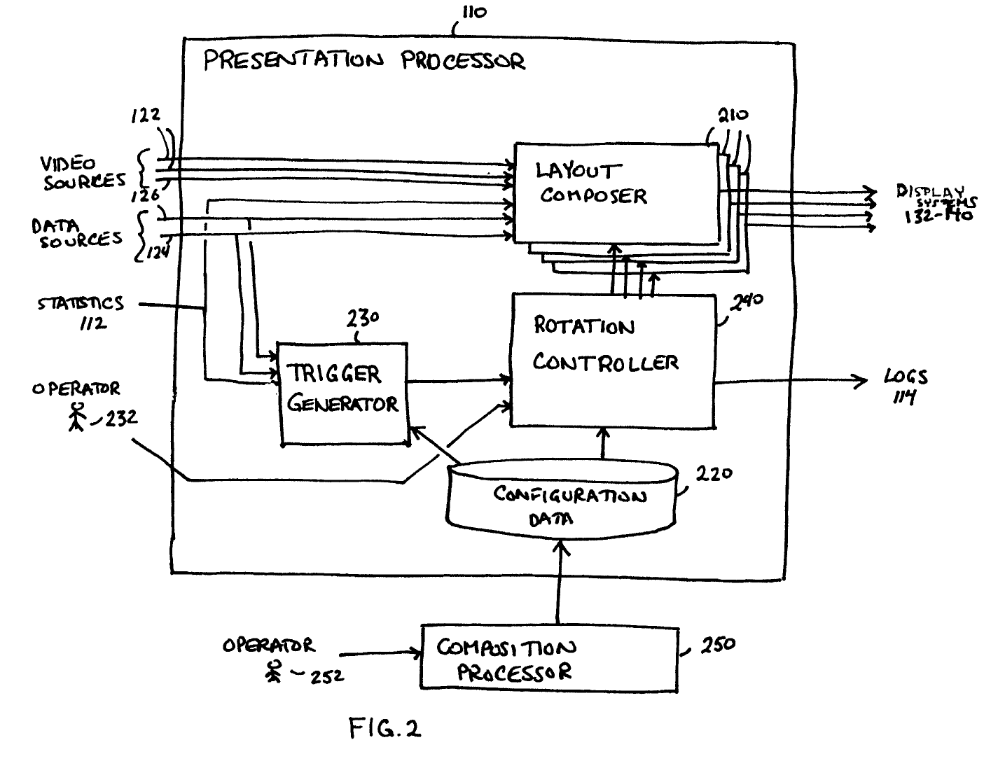

Referring to FIG. 2, presentation processor 110 is logically composed of a number of functional components. A separate layout composer 210 is associated with each display system 132-140. Each layout composer 210 takes as input a number of video signals from video sources 122, 126, and accesses data from data sources 124, 126 as well as from statistics 112, to compose the presentations for the display systems.

A trigger generator 230 monitors the data feeds from data source 124, external data feed 126, and changes in statistics 112, to identify occurrences of a set of defined triggering events. Occurrences of these triggering events affects the presentations displayed on the display systems. In particular, when trigger generator 230 detects an event, that event may initiate display of a sequence of one or more layouts on a particular one of the displays. Such a sequence of layouts is referred to as a “rotation”. A rotation controller 240 accepts indicators of the presence of particular triggers from trigger generator 230, and controls the selection and timing of layouts to display for each of the presentations.

Trigger generator 230 and rotation controller 240 make use of configuration data 220 that is typically stored prior to the live event. This configuration data includes definitions of the potential triggering events, and includes data characterizing the various rotations that may be triggered during the event. The data characterizing a rotation includes data that specifies the placement of elements on one or more layouts. Some of these elements identify frames within which video from one of the video sources is to be presented, while others identify dynamic data sources, such as game statistics (e.g. scores), while others identify static or predefined elements, such as graphical elements, or animations.

Prior to the live event, an operator 252 uses a composition processor 250 to store the configuration data. In this embodiment, the composition processor 250 includes a programmable computer workstation, including storage for computer code that implements the functionality of the composition processor.

Presentation processor 110 includes a programmable computer and special-purpose hardware for video composition. The programmable computer includes a storage for computer code that implements functionality of the presentation processor, including the functionality of trigger generator 230 and rotation controller 240, and in this embodiment includes special-purpose hardware that implements at least some of the functionality of layout composers 210.

Triggering events initiate display of rotations. In this embodiment, these rotations are formed of sequences of one or more layouts. It should be understood that in alternative embodiments, it is not necessary that any rotation have more than one layout. Furthermore, in alternative representations of rotations are possible in which discrete layouts are not separately defined. For example, rotations can be animations or specifications of time-varying arrangements of elements.

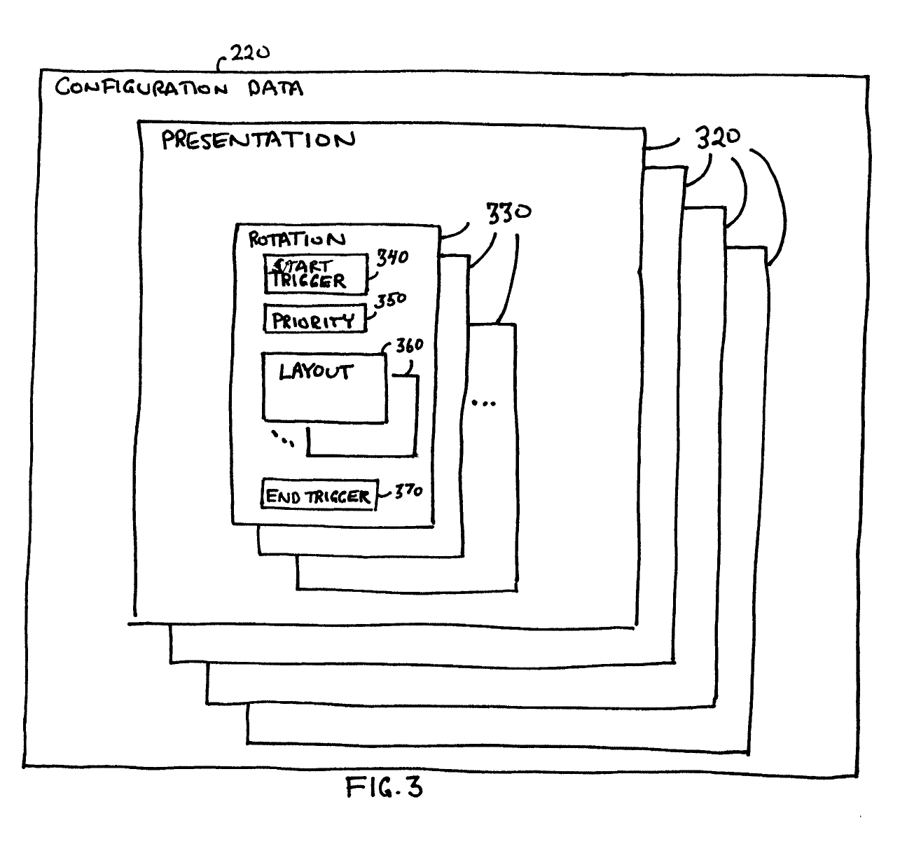

Referring to FIG. 3, configuration data 220 includes data structures that specify how the images for the various display systems are to be composed. The data includes specification of a number of “presentations” 320. At the time of the live event, each display system is associated with a particular presentation 320, which can be thought of as the specification of the programming for that display system. In FIG. 3, four presentations 320 are illustrated, one for each of the display systems fed by presentation processor 110. Configuration data 220 may include a library of presentations 320, for example, with different presentations stored for different events that may be upcoming at the venue that is supported by the presentation processor. However, during any one event, only a single presentation is typically used for any one of the display systems. Note however, that in alternative embodiments, a display system may be switched from one presentation 320 to another, for example, under manual control.

Each presentation 320 includes a number of “rotations” 330. In this embodiment, each rotation includes an ordered sequence of layouts 360. The rotation also includes a specification of a start trigger 340 associated with that rotation, and a priority 350 for the rotation. Start trigger 340 specifies when the rotation can be initiated. Priority 350 determines whether the rotation can preempt a currently executing rotation.

Start trigger 340 is configurable to be an absolute time, an occurrence of a particular event detected by trigger generator, or an event-time input from operator 232 (FIG. 2). In this embodiment, a rotation is initiated when its associated start trigger occurs and its priority is greater than the priority of the active rotation. In this embodiment, when a rotation is preempted by a higher-priority rotation, the lower-priority rotation terminates. In alternative embodiments, other behavior is possible, including suspension of the preempted rotation or masking of the preempted rotation.

Note that presentation 320 may include definitions of a large number of rotations 330, some of which may never be used at a particular event because their associated triggering events do not occur.

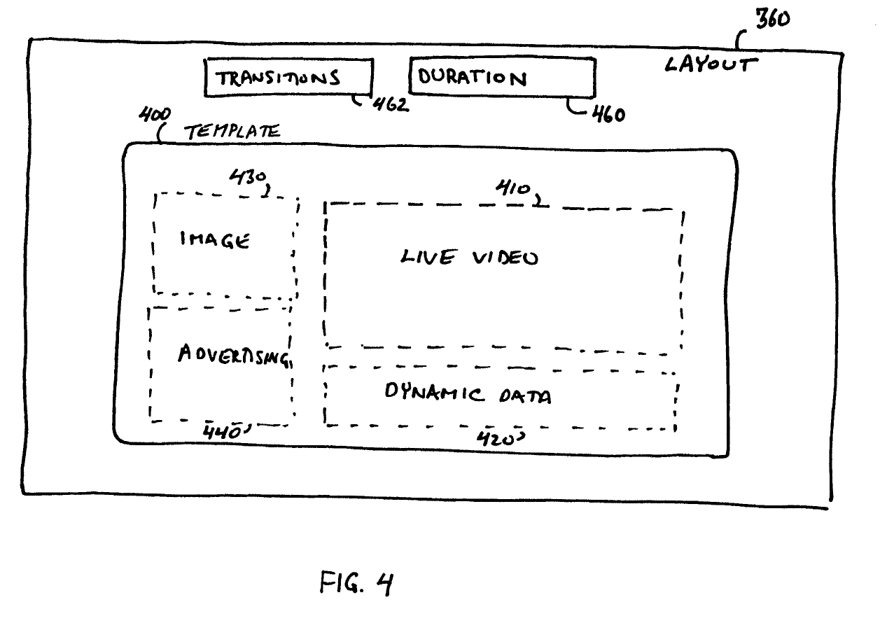

When a rotation 330 is displayed, each of its layouts 360 is displayed in turn (unless the rotation is preempted). Referring to FIG. 4, each layout 360 includes a duration 460 for which the layout is to be displayed and a specification of the type of transition 462 from the previous layout. In alternative embodiments, rather than specifying durations for the display of each layout, triggering events can be associated with the transitions between layouts, transitions from one layout to another occur when the associated triggering event occurs. Each layout includes a template 400, which defines the arrangement of a number of elements for display. In FIG. 4, a representative template 400 is illustrated to include a frame 410 for live video from one of the video sources, a frame 420 that includes an arrangement of text which may include text fields that are derived from the data sources or the stored statistics, a fixed graphics frame 440 such as an advertising logo, and a frame 430 that holds a dynamically selected static image, for example, a picture of a particular player chosen based on data from the data sources. For example, in a layout triggered by a scoring event, frame 410 may be live video of the event, frame 420 may include static text and dynamically generated text showing the score and the name of the scoring player, and frame 430 may be a static image of the scoring player.

In this embodiment, templates 400 are created using a commercial video composition product, such as Inscriber CG/Xtreme. This product is integrated in composition processor 250 (FIG. 2) allowing operator 252 to arrange elements in a template, and to associate various elements with statically or dynamically determined content.

Returning to FIG. 3, rotation 330 also includes an end trigger 370, which specifies when a rotation should terminate. End trigger 370 is configurable to identify whether the series of layouts 360 should be sequenced only once, repeated a fixed number of times, or looped repeatedly. End trigger 370 also includes a provision to identify a triggering event from trigger generator 230 or a manual trigger from operator 232 to terminate the rotation.

One rotation 330 is the default rotation that is displayed when no other triggered rotation is being displayed. For example, such a default rotation may include an infinite loop cycling between a number of layouts.

Referring again to FIG. 2, trigger generator 230 includes a number of data source specific predefined events, such as a touchdown for football and a dunk for basketball, that it searches for in the data streams obtained from data sources 124-126. For example, the predefined events include the start and end of a game or a period, a change of possession of the ball, a score, a start of a hockey power play, a timeout, or the end of a particular type of play. In addition to predefined events, operator 252 can add custom events to configuration data 220. These custom events include events that are specified as logical expressions that are associated with predefined events or with data stored in statistics 112. Examples of custom events include scores by particular players, scores that put the home team in the lead, a timeout in the last minute of play, the occurrence of 100 or more yards of rushing in a football game, or a score in a particular out-of-town game.

Composition processor 250 includes libraries of stored custom event definitions, layouts, and rotations. Operator 252 therefore can assemble configuration data 220 for a particular event from these library elements. Furthermore, composition processor 250 includes provisions for “cutting and pasting” elements between different layouts.

One application of custom events is to define circumstances and situations at which particular advertising is displayed. For example, a particular sponsor may purchase an advertisement that is to be displayed after each score by the home team. Another sponsor may purchase advertising at concession stands during timeouts of a game. A wide variety of narrowly tailored events can be defined prior to the live event to trigger display of rotations with particular advertising.

It is to be understood that the foregoing description is intended to illustrate and not to limit the scope of the invention, which is defined by the scope of the appended claims. Other embodiments are within the scope of the following claims.

What is claimed is:

1. A method for automatically presenting a live event comprising:
prior to the live event, (a) storing data characterizing a plurality of triggering events, (b) storing data characterizing a plurality of layout rotations, each layout rotation including one or more layouts, and (c) storing data associating each of the layout rotations with one of the triggering events; and
during the live event, (d) detecting instances of the triggering events, and (e) for each of said detected instances, automatically triggering presentation of a layout rotation associated with the triggering event.

2. The method of claim 1 further comprising:
during the event, automatically displaying the one or more layouts of the triggered layout rotations according the stored data characterizing said layout rotations.

3. The method of claim 2 wherein automatically displaying the one or more layouts includes displaying video of the live event.

4. The method of claim 3 wherein the video includes live video of the event.

5. The method of claim 3 wherein the video includes replay video of the event.

6. The method of claim 3 wherein the video includes slow-motion video of the event.

7. The method of claim 3 wherein the video includes animations.

8. The method of claim 3 wherein the video includes pre-recorded video.

9. The method of claim 3 wherein automatically displaying at least one of the one or more layouts further includes displaying text.

10. The method of claim 9 wherein the displayed text includes static text.

11. The method of claim 9 wherein the displayed text includes dynamic text derived from the external data sources.

12. The method of claim 3 wherein automatically displaying at least some of the layouts further includes displaying graphics.

13. The method of claim 3 wherein automatically displaying at least some of the layouts further includes displaying at least one of a plurality of advertisements.

14. The method of claim 13 wherein different advertisements are displayed during display of layout rotations that are triggered by different triggering events.

15. The method of claim 1 further comprising:
during the live event, receiving data related to the live event, and wherein the triggering events include events characterized in terms of said data related to the live event.

16. The method of claim 15 wherein receiving data related to the live event includes receiving data characterizing discrete events during a sporting event.

17. The method of claim 16 wherein receiving data characterizing a discrete event includes receiving data related to a scoring event, and said data includes data identifying a player who participated in said scoring event.

18. The method of claim 1 further comprising forming a plurality of separate presentations, each for display on a different one of a plurality of display systems, and wherein automatically triggering layout rotations during the event includes triggering different layout rotations for each separate presentation.

19. The method of claim 18 wherein the plurality of display systems includes a scoreboard display visible to an audience attending the live event.

20. The method of claim 18 wherein the plurality of display systems includes at least one television monitor at the venue of the live event.

21. The method of claim 18 wherein the plurality of display systems includes a television distribution system for displaying the event at locations other than at the venue of the live event.
